(19) United States
(12) Patent Application Publication
(10) Pub. No.: US 2022/0389754 A1
(43) Pub. Date: Dec. 8, 2022

(54) SILL FOR WATERTIGHT BUILDING OPENING ASSEMBLY EXTENSION

(71) Applicants: Wesley Greene, Goodlettsville, TN (US); Mike Bowers, Goodlettsville, TN (US)

(72) Inventors: Wesley Greene, Goodlettsville, TN (US); Mike Bowers, Goodlettsville, TN (US)

(21) Appl. No.: 17/834,106

(22) Filed: Jun. 7, 2022

Related U.S. Application Data
(60) Provisional application No. 63/197,975, filed on Jun. 7, 2021.

(51) Int. Cl. E06B 1/70

(52) U.S. Cl. CPC E06B 1/702; E06B 1/02

(57) ABSTRACT

A unified building opening extension system is pre-built offsite. In one embodiment, the extension system is a single sheet of metal cut, bent, and fixed in a predetermined size. The extension system provides an airtight, watertight assembly that is compatible with waterproofing and air barrier systems integrated with the assembly when the opening assembly (e.g. door or window), exterior insulation, and veneer are installed on the building wall. Water intrusion or leaks are resisted even under positive and negative air pressure events (i.e., winds and storms). A sill plate supports an opening assembly in a rough opening of the building and prevents water ingress into the rough opening.

### CROSS-REFERENCES TO RELATED APPLICATIONS

The application claims priority to and hereby incorporates by reference in its entirety U.S. Provisional Patent Application No. 63/197,975 entitled “WATERTIGHT BUILDING OPENING ASSEMBLY EXTENSION” filed on Jun. 7, 2021.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to commercial construction. More particularly, this invention pertains to creating window openings in buildings built with energy efficient construction techniques.

Standard construction designs have been modified to incorporate green (i.e., energy efficient) techniques. One such modification is adding a layer of rigid insulation to the exterior side of the interior cavity wall behind the veneer (e.g., brick face or siding). This requires that opening assemblies like windows, doors, and vent louvers to be moved outboard of the interior cavity wall to the face of the veneer. Thus, any gap or void between the exterior veneer and interior cavity wall assembly at the opening assemblies (e.g., windows, doors, and vent louvers) would be open to the interior of the building cavity, and there would be nothing to attach to the opening assembly to.

Currently, the gap or void between the exterior surface of the interior cavity wall and exterior insulation (i.e., the outside of the rigid foam insulation) and the veneer of the building is covered with a 20 to 24 gauge flat sheet stainless steel flashing that is fastened to the inside of the rough opening (of the interior cavity wall) and extends out to the veneer. A waterproof membrane and sealants are applied between the metal flashing and rigid foam insulation to create a watertight extension/enclosure. This design is problematic because waterproofing membrane and sealants applied to the exterior of the metal flashing and rigid foam insulation are what makes the current design watertight and they are subject to degrading over time. They cannot be serviced because once the opening assembly (e.g., window) and veneer are installed, those areas of the wall system become inaccessible. Exposed fasteners holding the flashing to the rough opening (i.e., the framing of the interior cavity wall) cause clearance issues with the opening assembly and possible leaks at the fasteners. Laps are created when attaching two pieces of metal flashing together to trim out the opening. The laps are sealed by installing sealant between the two pieces of metal and held together by putting fasteners through the metal layers. Problems include sealant failures from thermal cycling and movement, creeping at the laps, and failures at fasteners. The laps also create a step inside the joint opening between the metal and the rough opening assembly. This step has been known to leak during negative pressure chamber testing. Inconsistent corner bends, inconsistent flashing depths, and cuts in the metal flashing due to human error during field installation are also common issues. Metal flashing is not rigid enough to support sealant and backer rod. That is, when backer rod is installed between the opening assembly (e.g., window frame) and the metal flashing, pressure from the backer rod bows the metal flashing outwardly, away from the opening assembly (e.g., window frame) causing inconsistent joint sizes. This causes even more problems when the veneer is installed because the opening assembly is typically installed before veneer, making veneer joints inconsistent or difficult. This time consuming on site installation process causes coordination problems for multiple trades (e.g., window installers, veneer installers, masons, air barrier installers, sealant installers, etc.), and often results in multiple trades needing to be on job site at the same time to fix issues that arise. Most current designs specify stainless steel flashing, but stainless steel is expensive and lower grades of stainless will rust and cause staining of the exterior veneer. Additionally, extending rough openings in the interior cavity wall via fabrication and application of metal flashing on site is a safety concern for the field installers getting cuts to the hands and arms, some of which can be severe and result in construction delays. This design using site built stainless steel flashing is thus very time consuming to build, subject to failure, and ultimately costly for contractors and people hiring out building construction.

### BRIEF SUMMARY OF THE INVENTION

Aspects of the present invention provide a unified building opening extension system that is pre-built offsite. In one embodiment, the extension system is a single sheet of metal cut, bent, and fixed in a predetermined size. The extension system provides an airtight, watertight assembly that is compatible with waterproofing and air barrier systems integrated with the assembly when the opening assembly (e.g. door or window), exterior insulation, and veneer are installed on the building wall. Water intrusion or leaks are resisted even under positive and negative air pressure events (i.e., winds and storms).

In one aspect of the invention, a building opening assembly extension system includes a frame. The frame has at least three sides. Each side includes a mounting flange and an extension wall. The mounting flange is configured to attach to an exterior surface of an interior cavity wall about a rough opening through the interior cavity wall and extend outwardly from the rough opening when attached to the exterior surface of the interior cavity wall about the rough opening. The extension wall is configured to extend from the mounting flange away from the exterior surface of the interior cavity wall to or past a veneer of the building when the mounting flange is attached to the exterior surface of the interior cavity wall about the rough opening and the veneer is installed.

In another aspect of the invention, a method of forming a building opening assembly extension system includes cutting a length of material to a predetermined length to fabricate a frame of the building opening assembly extension system. The length of material extends longitudinally. A hem is bent up along an outer edge of the length of material to form an outer edge of an extension wall of the frame. A mounting flange is bent up along an inner edge of the length of material to form an inner edge of the extension wall of the frame. The mounting flange is cut through a laterally from an outer edge of the mounting flange to the inner edge of the extension wall of the frame a plurality of predetermined longitudinal points to form corners of the frame. The length of material is bent laterally at the plurality of predetermined longitudinal points such that the length of material forms a plurality of sides of the frame. Each side of the frame includes a mounting flange and an extension wall with a hem along an outer edge of the extension wall.

### BRIEF DESCRIPTION OF THE SEVERAL VIEWS OF THE DRAWINGS

FIG. 1 is a PRIOR ART isometric cutaway view of a building wall including exterior insulation (i.e., insulation outside of an exterior surface of an interior cavity wall of the building).

FIG. 2 is a front perspective view of a building opening assembly extension system installed on a building opening installed on an exterior surface of a building interior cavity wall according to one embodiment of the invention. Certain sealant beads and waterproof membranes are omitted for clarity.

FIG. 3 is a side cutaway view of a building wall including the building opening assembly extension system of FIG. 2.

FIG. 4 is an isometric view of a building opening assembly extension system according to one embodiment of the invention.

FIG. 5 is a rear isometric view of an opening assembly mounted into a rough opening of an interior cavity wall of a building.

FIG. 6 is a side perspective view of a lap joint of a building opening assembly extension system.

FIG. 7 is a side perspective view of a corner support being installed in a building opening assembly extension system between adjacent mounting flanges.

FIG. 8 is a side perspective view of a frame of a building opening assembly extension system prior to a mounting flange to extension wall angle being bent back from 95-115 degrees to 90 degrees.

FIG. 9 is a side perspective view of a sill plate according to one embodiment of the invention.

FIG. 10 is a side cutaway view of a building wall including a sill plate according to one embodiment of the invention.

FIG. 11 is a side cutaway view of a building wall including a sill plate and a frame according to one embodiment of the invention.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. As described herein, the upright or natural resting position of the system is properly installed on a generally vertical wall in a rough opening. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without operator input or prompting, whether these features, elements and/or states are included or are to be performed in any particular embodiment.

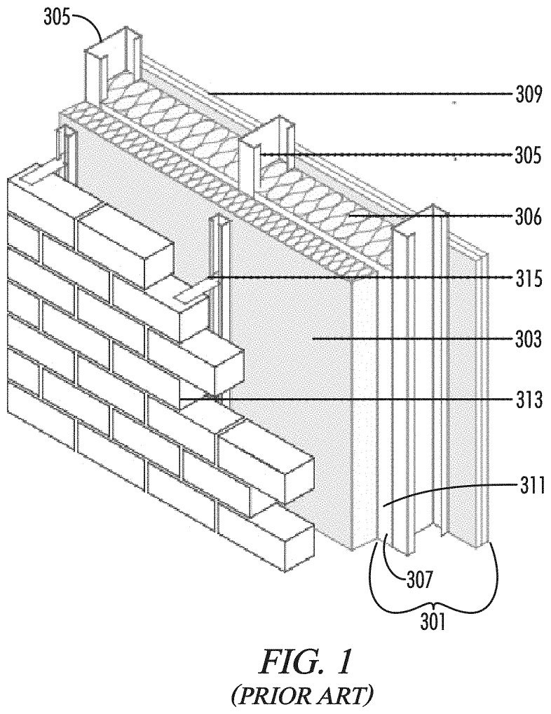

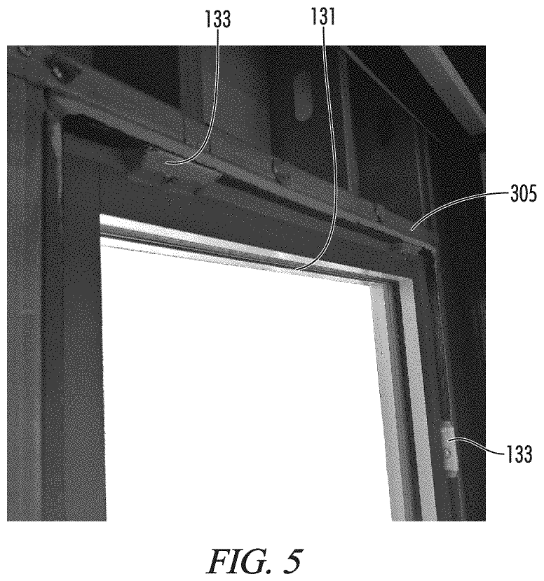

Referring to PRIOR ART FIG. 1, energy efficient building wall systems 300 include a traditional interior cavity wall 301 and exterior insulation (e.g., rigid foam insulation sheets) 303. The interior cavity wall 301 is based around framing 305 (e.g., metal or wood studs, headers, and sills). Spaces between framing 305 are filled with insulation 306 (e.g., spray foam, fiberglass, rockwool, hemp, etc.). The outside of the interior cavity wall 301 is formed by exterior sheathing 307 (e.g., sheet metal, oriented strand board, or similar synthetic product). In rough openings, flashing (e.g., a self adhering waterproof membrane) is wrapped from the framing 305 onto the exterior sheathing 307. Optionally, the framing 305 forming and facing the rough opening 103 may be wrapped in drywall, wood, or some other cladding material (see FIG. 5 for example). A low vapor permeability coating is then optionally applied to the waterproof membrane and exterior sheathing 307. On the inside surface of the interior cavity wall 301, drywall 309, green board, concrete backer board, or other known building interior finish products are attached to the framing 305 to complete the interior cavity wall 301. Exterior insulation 303 is attached to an exterior surface 311 of the interior cavity wall 301 (i.e., against the low vapor permeability coating on the sheathing 307). A building veneer 313 (e.g., brick, vinyl siding, wood siding, or fiber cement siding) is then attached to the exterior insulation 303, and brick ties and/or vertical strapping 315 may be used to space the veneer 313 from the exterior insulation 303.

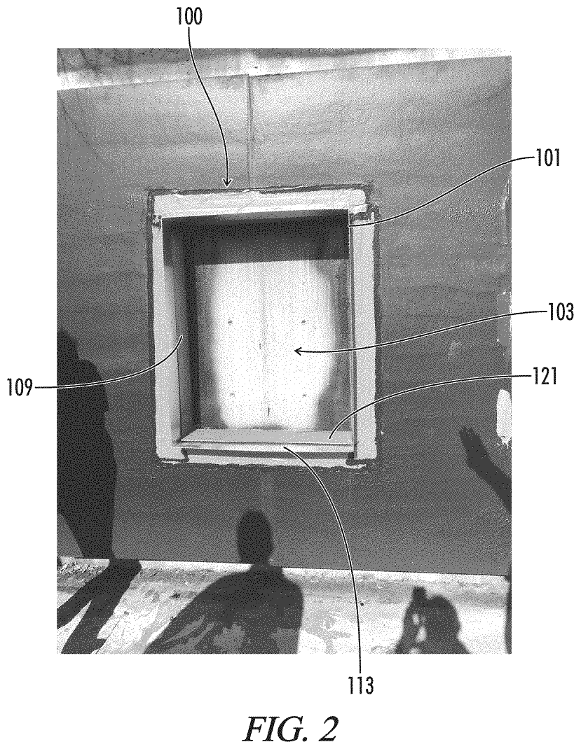

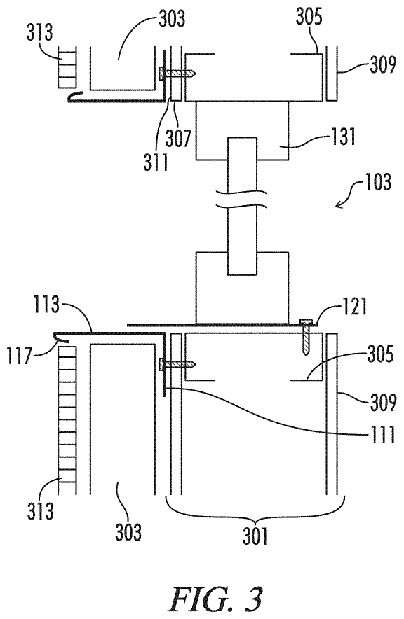

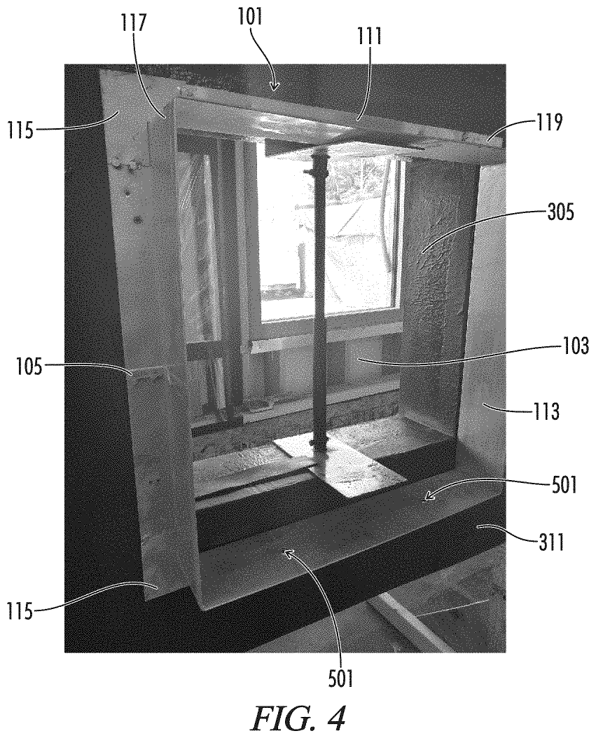

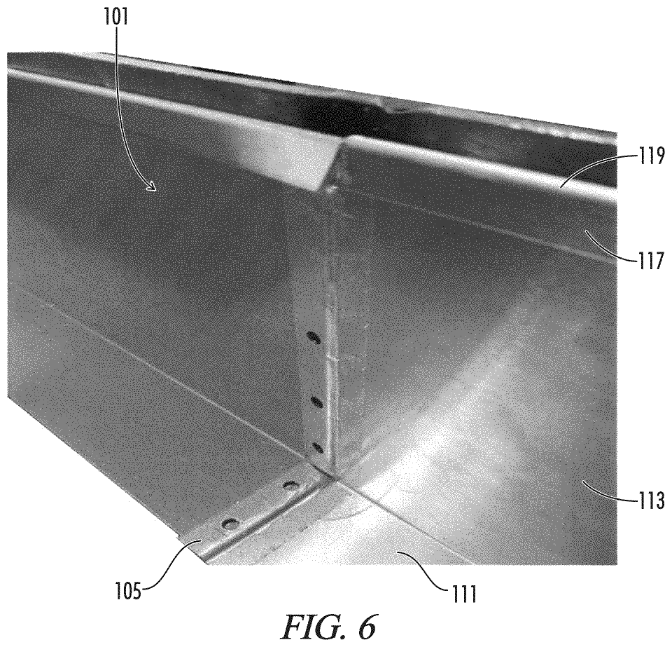

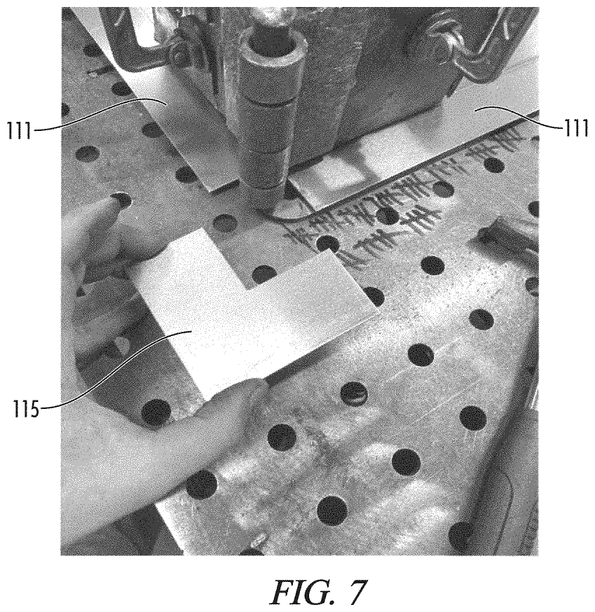

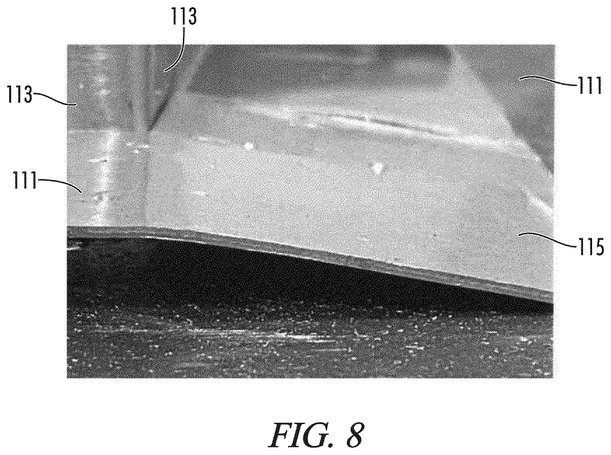

Referring now to FIGS. 2-8, a building opening assembly extension system 100 includes a frame 101. The frame 101 has at least three sides 109 and, more typically, four sides 109. In one embodiment, the frame 101 has a top side, two opposing vertical sides, and a bottom or sill side. In one embodiment, each of the extension walls 113 of the frame 101 is continuous with at least one other extension wall 113 of the frame 101. In one embodiment, the opposing vertical sides 109 of the frame 101 are taller or longer than a height of the rough opening 103 such that the bottom side of the frame 101 is mounted to the exterior surface 311 of the interior cavity wall below a bottom or sill of the rough opening 103 when the system 100 is installed to the rough opening 103. In one embodiment, the extension walls 113 of the frame 101 are formed from a single, continuous piece of material. In another embodiment, the frame 101 is formed of a polymer, either by bending and adhering the polymer as described below with respect to sheet-metal, or by injection molding or other method of forming 3D objects with polymer.

Each side 109 includes a mounting flange 111 and an extension wall 113. The mounting flange 111 is configured to attach to the exterior surface 311 of the interior cavity wall 301 about a rough opening 103 in or through the interior cavity wall 301. The mounting flange 111 extends outwardly from the rough opening 103 when attached to the exterior surface 311 of the interior cavity wall 301 about the rough opening 103. The extension wall 113 is configured to extend from the mounting flange 111 away from the exterior surface 311 of the interior cavity wall 3012 or past a veneer 313 of the building when the mounting flange 111 is attached to the exterior surface 311 of the interior cavity wall 301 about the rough opening 103 and the veneer 313 is installed on the building. In one embodiment, the frame 101 is formed of a corrosion resistant material or metal, and the frame 101 includes at least one of aluminum or stainless steel. In one embodiment, the frame 101 further includes a corner support 115. The corner support 115 is attached to adjacent mounting flange is 111 at each corner (i.e., intersection of adjacent extension walls 113) of the frame 101. In one embodiment, an angle between the mounting flange 111 and extension wall 113 of each side 109 is maintained at between approximately 95 and hundred and 5° while bending a single piece of material or metal to form the sides 109 of the system 100. After the corner supports 115 are attached to the frame 101 between each pair of adjacent mounting flange is 111, the angle between each mounting flange 111 and extension wall 113 from which the mounting flange 111 extends is bent to approximately 90° in order to add rigidity to the frame 101 by pre-stressing the frame 101.

In one embodiment, each extension wall 113 of the frame 101 includes a hem 117. The hem 117 extends outwardly from and back from an outer edge 119 of the extension wall 113 toward the mounting flange 111 from which the extension wall 113 extends. Each hem 117 is continuous with at least one other hem 117 of the frame 101. The hems 117 cooperate to increase rigidity of the frame 101. In one embodiment, the hem 117 forms a J channel. In one embodiment, the hem and 17 is filled with a sealant or other filler.

In one embodiment, exactly one of the extension walls 113 has a lap joint 105 such that the extension walls 113 are continuous about the rough opening 103 when the mounting flange 111 is attached to the exterior surface 311 of the interior cavity wall 301 about the rough opening 103. In one embodiment, the lap joint 105 is partially welded and partially filled with urethane or another sealant to provide material compatible surfaces when installing flashing membranes and sealants onto the system 100 and exterior surface 311 of the interior cavity wall 301. In one embodiment, the lap joint 105 is fully welded, and the lap joint 105 may optionally be a butt joint such that forming a step at the lap joint 105 becomes superfluous.

In one embodiment, the system 100 further includes a sill plate 121. In one embodiment, the sill plate 121 is generally flat. The sill plate 121 is configured to mount to a bottom of the rough opening 103 in the interior cavity wall 301 and extend outward past the exterior surface 311 of the interior cavity wall 301.

In on embodiment, a unified, prefabricated rough opening extension system 100 is provided. A frame 101 of the system 100 is fabricated off site (from the building being built) from a single length of material (e.g., metal or polymer flashing). An outer edge 119 of the frame 101 is hemmed. A single lap joint 105 is at a vertical side 109 (i.e., not top, bottom or corner) of the extension system 100. The lap joint 105 is partially welded at a portion which will be contacted by a sealing membrane when the system 100 is waterproofed onto the exterior surface 311 of the interior cavity wall, and a portion of the lap joint 105 is sealed with urethane in an area that will not be contacted by the membrane. Urethanes and asphalt sealant materials can cause incompatibilities that lead to premature waterproofing failure of the overall wall 300. The system 100 eliminates exposed fasteners, creates a lap 105 with no step, makes a more rigid extension system compatible with backer rod and sealant, and can be mounted inboard or outboard of the interior cavity wall 301. That is, the mounting flange 111 may be mounted to a vertical surface of the interior cavity wall 301 whether that vertical surface is the exterior surface 311 or the interior surface of the framing 305 or drywall 309 of the interior cavity wall 301.

In one embodiment, the system 100 includes a bent metal frame 101 with corner supports 115 attached thereto as well as various other waterproofing materials, fasteners, and membranes to adhere the frame 101 with corner supports 115 to the interior cavity wall 301 of the building. A mounting flange 111 of the frame 101 changes the mounting of the frame 101 to the exterior surface 311 of the interior cavity wall 301 instead of mounting to the inside of the rough opening 103 in the building wall (i.e., not to an interior surface of the framing or drywall of the interior cavity wall 301, but to the frame 305 surfaces perpendicular to the exterior surface 311 of the interior cavity wall 301). By doing this, the fasteners can be encapsulated in waterproofing air barrier membrane instead of piercing the extension walls of the system.

When mounting the system frame 101 to the building, the sheathing board joints and voids are typically caulked. Then, a layer of waterproofing air barrier membrane is applied to the sheathing board 307. This provides the system frame 101 a watertight substrate to attach to. A bead of sealant is applied to the backside (i.e., interior cavity wall side) of the flange 111. The system frame 101 is aligned with the rough opening 103 and pressed into place. Fasteners (e.g., screws or nails) and sealant are used to secure the mounting flange 111 to the wall (i.e., to the framing 305 in the interior cavity wall 301). This ensures the fastener threads are sealed. A self adhereing waterproof flashing membrane is then installed over the mounting flange 111. The extension of the flashing from the frame 101 and onto the frame 101 will be specified by the waterproofing air barrier manufacturer. The specified distance is typically 3 to 4 inches and the outer seam is sealed with sealant specified from the waterproofing air barrier manufacturer.

The system frame 101 is completed with a single lap joint 105. A stepped flange is added to one of the two ends of the single, continuous piece of material forming the extension walls 113 of the frame 103 and mounting flanges 111 such that when the second end is attached to the first end, it creates a smooth lap on the inside of the frame 101 (e.g., inside and building facing side) where sealant is applied to the opening assembly (i.e., to the window, door, or vent). The step creates a joint between two pieces on the wall side (e.g., outside of the extension wall 113) and opening assembly (e.g., window or door) side where sealant is applied to the system frame in the opening assembly side. This seals the lap 105 from inside.

In one embodiment, the system frame 101 is fabricated in a fixture or jig. This allows repeatable tight tolerances and consistencies on each system frame 101 built.

In one embodiment, aluminum is selected for the frame 101 because most opening assemblies (e.g., window and door frames) are built from aluminum. Thus, corrosion due to materials incompatibility is assured, and differences in thermal expansion between the extension system 100 and the opening assembly (e.g., window or door) are eliminated. Stainless Steel has adverse reaction when it comes in contact with aluminum, but may be used if specified by the building owner. Material deflection may occur when using 0.040 to 0.050 Aluminum. To prevent this deflection a hem 117 edge extends around the extension wall 113 outer edge 119 in order to stiffen the outer edge 119. Different shapes can be added to the outer edge for different cosmetic appearance like a 90 degree, 45 degree, or a box bend (e.g., a siding type J Channel profile) to stiffen this outer edge 119.

In one embodiment, the mounting flange 111 to extension wall 113 angle is short of 90 degrees by approximately 10 to 15 degrees (i.e., is approximately 95 to 115 degrees) when bending or folding the frame 101 into shape such that when fastened in place, the distortion of the extension walls 113 is inward toward the opening assembly. In this way, any distortion, tension, or prestress is working to put extra tension inward on the opening assembly (e.g., door frame or window frame) to hold backer rod in place for sealant installation and create a uniform gap or reveal about the opening assembly frame. However, this arrangement can cause the frame 101 not sit flat in the fabrication jig resulting in inconsistent dimensions. To remedy this, in one embodiment, the frame 101 is assembled with a flange to extension wall angle between about 75 and 80 degrees. After the lap joint 105 is welded, each mounting flange 111 is placed in a brake, and the angle is changed back to approximately 100 degrees. The corner supports 115 are then attached, and the mounting flanges 111 are bent back to 90 degrees. If a more uniform joint is desired a double sided adhesive foam tape is added. By doing this a pre-determined uniformed joint is made for sealant and backer rod abutting the opening assembly. Alternatively, the jig can include a raised section corresponding to the extension walls 113 such that the mounting flange 111 to extension wall 113 angle can remain at about 95-115 degrees throughout bending, welding the lap joint 105, and attaching the corner supports 115.

In one embodiment, the hem 117 is filled with sealant or another filler to prevent water and air from following the channel created in the hem 117 to the lap joint(s) 105 and potentially migrating into the lap joints 105 then into the structure (building). In one embodiment, welds are used at the lap joint 105 and corner supports 115 to prevent materials incompatibility between asphalt waterproofing and sealants. In one embodiment, the extension walls 113, mounting flanges 111, and corner supports 115 are formed with aluminum or stainless steel to promote sealant adhesion as some sealants have problems adhering to plastics and are prone to distortion when subjected to hot temperatures.

The system frame 101 has the ability to be mounted to the inside (i.e., drywall side) or outside 311 of the interior cavity wall 301 opening 103. In the event that clearance is an issue with the flanges 111 when mounted to the exterior surface 311, the mounting flanges 111 can be moved to the inboard side (assuming the extension walls are extended to the appropriate length to reach out to the veneer 313. Another reason for the inboard mount is the system frame 101 prevents damage from occurring to the waterproofing in the opening 103 during installation of the opening enclosure (i.e., opening assembly, window, or door). Another advantage to inboard mounting is that an additional layer of protection is added when the rough opening 103 is waterproofed (i.e., flashed and sealed), reducing the potential for leaks to the building interior cavity from the primary waterproofing (external water barrier) if a failure of that waterproofing membrane and/or sealants occurs.

Additionally, if a bead of sealant is added to the interior side of the opening enclosure (e.g., window frame) to the system frame 101 negative pressure on the overall opening closure (i.e., extension assembly, waterproofing, and opening assembly) created during weather events is reduced. Negative pressures commonly cause or worsen leaks from failures of the opening enclosure (e.g., window frame, glaze, etc.). Another advantage to the inboard mount is that when the interior bead of sealant and weep baffles are added to the system frame 101, the chance of leaks can be greatly reduced. It is common to have weep baffles, tubes or holes added to the window and door assemblies (i.e. opening enclosure). The problem with weep baffles or tubes is that they are added to the exterior side of the opening assembly where water can be blown into them, or bugs will nest in the opening, stopping them up. With the system frame 101 installed, the weep baffle is on the bottom inside the wall cavity where it is protected from the elements and bugs. The baffles drain into the wall cavity where it cannot enter the structure. In typical designs in use today the watertight bead of sealant is to the exterior of the opening assembly like windows and doors. They typically fail which leads to leaks and water infiltration into the structure. With the interior bead added and baffles or drains, the entire opening enclosure (e.g., opening assembly) can fail and not leak inside the building. The water is contained in the bottom of the system frame 101 then drained to the outside of the inner cavity wall 301. This can be done with the outboard mount or the inboard mount of the frame 101.

In one embodiment, a method of forma building opening assembly extension system 100 includes cutting a length of material to a predetermined length to fabricate the frame 101 of the building opening assembly extension system 100. The length of material extends longitudinally. The length of material or metal is measured, punched for tack welds at the lap joint 105, and cut laterally at predetermined distances corresponding to the corners (i.e., intersection of adjacent extension walls 103) of the frame 101. These lateral cuts through the mounting flange 111 from an outer edge of the mounting financial 11 to an inner edge of the extension wall 113 of the frame 101 may be done before or after the length of material is bent to form the plurality of adjacent extension walls 113. In one embodiment, 2 lengths of metal are used such that 2 lap joints 105 are formed in opposing vertical sides 109 of the frame 101, and in another embodiment, the entire frame 101 is formed from one length of metal (plus corner supports 115) such that a single lap joint 105 is created. The length of metal is stepped at one longitudinal end of the length of metal to form the step for the lap joint 105. The hem 117 is bent up along an outer edge of the length of material to form an outer edge 119 of the extension wall 113 of the frame 101. The hem 117 is bent outwardly where the stepped lap joint 105 is to be created so that one end of the hem 117 can be tucked into the other end of the hem 117. The mounting financial 11 is bent up along an inner edge of the length of material to form an inner edge of the extension wall 113 of the frame 101. The length of metal is placed in the jig, clamped, and folded about the corners. That is, the length of material is bent laterally at the plurality of predetermined longitudinal points such that the length of material forms a plurality of sides 109 of the frame 101, each side 109 including a mounting financial 11 and an extension wall 113 with the hem 117 along an outer edge 119 or perimeter of the extension wall(s) 113.

A number of corner supports 115 are created by cutting a square notch from a piece of metal. The corner supports 115 are welded into place on each pair of adjacent flanges 111. The hem 117 and lap joint 105 are connected and welded. The weld is continuous along the hem and at least half way back from the front or outer edge 119 of the extension wall 113 toward to the mounting flange 111. The frame 101 is then removed from the jig, and the corner supports 115 are continuously welded along the back (i.e., building side) of the frame 101 to the corresponding adjacent mounting flanges 111. The welds are ground flat, and the hem 117 is filled with sealant. The inner side of the lap joint 105 is also coated with sealant. The outer portion of the lap joint 105 to be contacted by asphalt membranes and sealants when the system 100 is installed on the exterior surface 311 of the cavity wall along with the veneer 313 (and optionally the exterior insulation 303) is not sealed with sealant in order to prevent materials incompatibilities and failures. That section of the lap joint 105 is instead welded.

In one embodiment, a frame 101 is fabricated using a corner lap seam 105 according to one embodiment of the invention. A lap seam backer looks like a length of angle iron. The lap seam backer is cut to fit between the mounting flange 111 and the hem 117 or outside edge 119 of the extension wall 113. The lap seam 105 backer is fitted into place and welded to the adjacent extension walls 113 to which it has been fitted. The seams are ground flat, and the inside of the corner is welded and, optionally, covered with sealant. Optionally, the interior of the corner may be fully welded and/or sealed with sealant.

Once the system 100 is mounted to the interior surface or exterior surface of the inner cavity wall 301, the opening enclosure or opening assembly 131 can be installed in the opening. The opening assembly includes tabs 131 extending inward toward the building interior from an interior side of the opening assembly 131. The tabs 131 are secured to the framing 305 of the interior cavity wall 301 via screws or nails. A bead 135 of sealant or caulking is then applied to the interior side of the opening assembly 131 between the opening assembly 131 and the rough opening 103 (or the extension walls 113 and/or sill plate 121 when the system 100 is mounted inboard with the mounting flange 111 on the interior side of the interior cavity wall 301).

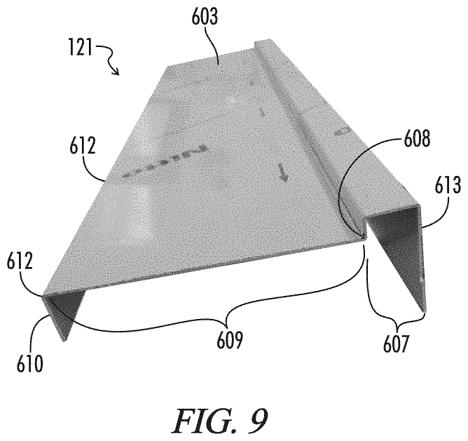

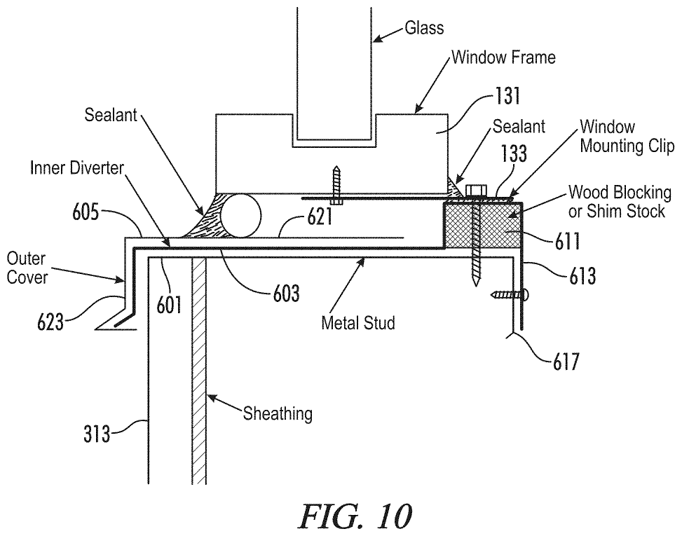

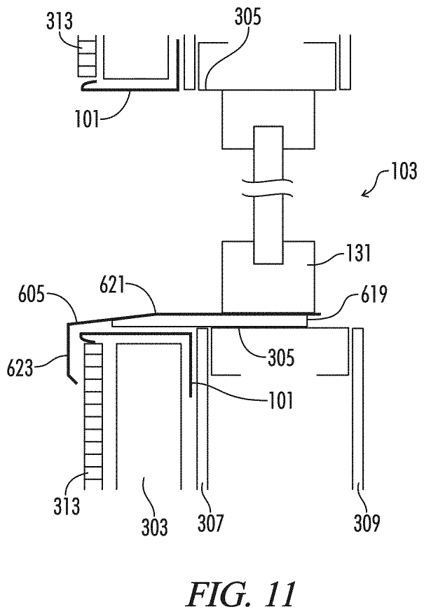

Referring to FIGS. 9-11, in one embodiment, a building opening assembly extension system 100 includes a sill plate 121. The sill plate 121 is configured to extend from a rough opening 103 of an inner cavity wall 301 of the building outward past the veneer 313 of the building and below a top 601 of the veneer 313 when the veneer 313 is installed on the building in the sill plate 121 is installed in the rough opening 103. An opening assembly 131 installed in the rough opening 103 is supported by the sill plate 121. In one embodiment, the sill plate 121 includes an inner diverter 603 configured to extend from behind the opening assembly 131 installed in the rough opening 103 outwardly from the rough opening 103 to past the veneer 313 of the building when the inner diverter 603, opening assembly 131, and veneer 313 are installed on the building. In one embodiment, the inner diverter 603 includes a dam portion 611, and extension portion 609, and a cover portion 610. The dam portion 607 is connected to an inner edge 608 of the extension portion 609 and protrudes higher than the extension portion 609 when the sill plate 121 is installed on the building. The cover portion 610 is connected to an outer edge 612 of the extension portion 609 and extends downward from the extension portion 609 below a top 601 of the veneer 313 when the sill plate 121 and veneer 313 are installed on the building. In one embodiment, the sill plate 121 further includes a block 611 supporting and at least partially filling the dam portion 607 of the inner diverter 603. In one embodiment, the dam portion 607 has a rear face 613 configured to extend below the rough opening 103 and attached to an interior side of the interior cavity wall 301. The interior side of the interior cavity wall 301 is formed by the frame 305, or by interior wall cladding such as drywall 309. In one embodiment, the sill plate 121 is configured to extend substantially completely between opposing vertical sides 615 of the rough opening 103. In one embodiment, the dam portion 607 is configured to support a mounting tab 133 of the opening assembly 131 such that the opening assembly 131 is spaced upward from the extension portion 609 when the sill plate 121 and opening assembly 131 are installed in the rough opening 103.

In one embodiment, the sill plate 121 includes an outer cover 605 configured to extend from under the opening assembly 131 to past the veneer 313 when the sill plate 121, opening assembly 131, and veneer 313 are installed on the building. In one embodiment, the sill plate includes a plurality of spacers 619, and the outer cover 605 includes a top 621 and a front 623. The spacers 619 are configured to support the top 621 of the outer cover 605 such that an air gap exists between the top 621 of the outer cover 605 and a surface below the top 621 of the outer cover 605. The surface below the top 621 of the outer cover 605 is one of a bottom of the rough opening 103, the inner diverter 603, or an extension wall 113 of the frame 1014 and inboard mounted frame 101. The spacers 619 are further configured to space the front 623 of the outer cover 605 from a surface behind the front 623 of the outer cover 605. The surface behind the front 623 of the outer cover 605 is one of an outer face of the veneer 313 or a cover portion 610 of an inner diverter plate 603. In one embodiment, the spacers 619 are shorter toward the front of the outer cover 605 such that the top 621 of the outer cover 605 is inclined with respect to the surface below the top 621 of the outer cover 605. In one embodiment, the inner diverse or 603 and outer cover 605 are each formed by bending a single piece of sheet metal.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims

Thus, although there have been described particular embodiments of the present invention of a new and useful SILL FOR WATERTIGHT BUILDING OPENING ASSEMBLY EXTENSION it is not intended that such references be construed as limitations upon the scope of this invention except as set forth in the following claims.

What is claimed is:

1. A building opening assembly extension system, said system comprising:
a sill plate configured to extend from a rough opening of an inner cavity wall of a building past a veneer of the building and below a top of the veneer of the building when the veneer is installed on the building and the sill plate is installed in the rough opening, wherein an opening assembly installed in the rough opening is supported by the sill plate.

2. The system of claim 1, wherein:
the sill plate comprises an inner diverter configured to extends from behind the opening assembly installed in the rough opening outwardly from the rough opening to past the veneer of the building when the inner diverter, opening assembly, and veneer are installed on the building.

3. The system of claim 1, wherein:
the sill plate comprises an inner diverter configured to extends from behind the opening assembly installed in the rough opening outwardly from the rough opening to past the veneer of the building when the inner diverter, opening assembly, and veneer are installed on the building;
the inner diverter comprises a dam portion, an extension portion, and a cover portion;
the dam portion is connected to an inner edge of the extension portion and protrudes higher than the extension portion when the sill plate is installed on the building; and
the cover portion is connected to an outer edge of the extension portion and extends downward from the extension portion below a top of the veneer when the sill plate and veneer are installed on the building.

4. The system of claim 1, wherein:
the sill plate comprises an inner diverter configured to extends from behind the opening assembly installed in the rough opening outwardly from the rough opening to past the veneer of the building when the inner diverter, opening assembly, and veneer are installed on the building;
the inner diverter comprises a dam portion, an extension portion, and a cover portion;
the dam portion is connected to an inner edge of the extension portion and protrudes higher than the extension portion when the sill plate is installed on the building;
the cover portion is connected to an outer edge of the extension portion and extends downward from the extension portion below a top of the veneer when the sill plate and veneer are installed on the building; and
the sill plate further comprises a block supporting and at least partially filling the dam portion of the inner diverter.

5. The system of claim 1, wherein:
the sill plate comprises an inner diverter configured to extends from behind the opening assembly installed in the rough opening outwardly from the rough opening to past the veneer of the building when the inner diverter, opening assembly, and veneer are installed on the building;
the inner diverter comprises a dam portion, an extension portion, and a cover portion;
the dam portion is connected to an inner edge of the extension portion and protrudes higher than the extension portion when the sill plate is installed on the building; and
the cover portion is connected to an outer edge of the extension portion and extends downward from the extension portion below a top of the veneer when the sill plate and veneer are installed on the building.

6. The system of claim 1, wherein:
the sill plate comprises an inner diverter configured to extends from behind the opening assembly installed in the rough opening outwardly from the rough opening to past the veneer of the building when the inner diverter, opening assembly, and veneer are installed on the building;
the inner diverter comprises a dam portion, an extension portion, and a cover portion;
the dam portion is connected to an inner edge of the extension portion and protrudes higher than the extension portion when the sill plate is installed on the building;
the cover portion is connected to an outer edge of the extension portion and extends downward from the extension portion below a top of the veneer when the sill plate and veneer are installed on the building; and
the dam portion has a rear face configured to extend below the rough opening and attach to an interior side of the interior cavity wall.

7. The system of claim 1, wherein:
the sill plate is configured to extend substantially completely between opposing vertical sides of the rough opening.

8. The system of claim 1, wherein:
the sill plate comprises an inner diverter configured to extends from behind the opening assembly installed in the rough opening outwardly from the rough opening to past the veneer of the building when the inner diverter, opening assembly, and veneer are installed on the building;
the inner diverter comprises a dam portion, an extension portion, and a cover portion;
the dam portion is connected to an inner edge of the extension portion and protrudes higher than the extension portion when the sill plate is installed on the building;
the cover portion is connected to an outer edge of the extension portion and extends downward from the extension portion below a top of the veneer when the sill plate and veneer are installed on the building; and
the dam portion is configured to support a mounting tab of the opening assembly such that the opening assembly is spaced upward from the extension portion when the sill plate and opening assembly are installed in the rough opening.

9. The system of claim 1, wherein:
the sill plate comprises an outer cover configured to extend from under the opening assembly to past the veneer when the sill plate, opening assembly, and veneer are installed on the building.

10. The system of claim 1, wherein:
the sill plate comprises an inner diverter;
the sill plate comprises an outer cover,
the outer cover is configured to extend from under the opening assembly to past the veneer and below a cover portion of the inner diverter when the sill plate, opening assembly, and veneer are installed on the building.

11. The system of claim 1, wherein:
the sill plate comprises an outer cover configured to extend from under the opening assembly to past the veneer when the sill plate, opening assembly, and veneer are installed on the building;
the sill plate comprises a plurality of spacers;
the outer cover comprises a top and a front;
the spacers are configured to support the top of the outer cover such that an air gap exists between the top of the outer cover and a surface below the top of the outer cover; and
the spacers are configured to space the front of the outer cover from a surface behind the front of the outer cover.

12. The system of claim 1, wherein:
sill plate comprises an outer cover configured to extend from under the opening assembly to past the veneer when the sill plate, opening assembly, and veneer are installed on the building;
the sill plate comprises a plurality of spacers;
the outer cover comprises a top and a front;
the spacers are configured to support the top of the outer cover such that an air gap exists between the top of the outer cover and a surface below the top of the outer cover; and
the spacers are shorter toward the front of the outer cover such that the top of the outer cover is inclined with respect to the surface below the top of the outer cover.

13. The system of claim 1, wherein:
the sill plate comprises an inner diverter formed by bending a single piece of sheet metal.

14. The system of claim 1, wherein:
the sill plate comprises an outer cover formed by bending a single piece of sheet metal.

15. The system of claim 1 further comprising a frame.
